(19) United States
(12) Patent Application Publication
(10) Pub. No.: US 2010/0088850 A1
(43) Pub. Date: Apr. 15, 2010

(54) HINGE COVER FOR EXTERNAL VEHICLE HINGES

(76) Inventor: Steven A. Dringenberg, Camino, CA (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/248,116

(22) Filed: Oct. 9, 2008

(51) Int. Cl. E05D 11/00

(52) U.S. Cl. 16/251

(57) ABSTRACT

A hinge cover assembly for covering an external door hinge disposed on the exterior surface of a vehicle is provided. The hinge cover assembly comprises a hinge cover and a mounting bracket. The mounting bracket is attached to the external door hinge and the hinge cover is attached to said mounting bracket.

### TECHNICAL FIELD

Generally, the present invention relates to a hinge cover. More particularly, the present invention relates to a hinge cover for covering the exposed external hinge, or at least the exposed external attachment body components of the hinge, attached to the outside of a door or hood of a vehicle.

### BACKGROUND ART

Various vehicles, including utility type vehicles such as off-road vehicles, and other sport-utility vehicles, are often produced with doors, and sometimes hoods, that, in addition to opening and closing, are designed with enhanced functionality. In some instances, in order to provide this enhanced functionality, the doors of these vehicles may be configured so that the hinge used to allow the door to open and close is mounted in locations that deviate from configurations found on traditional automobiles or trucks. For example, the structural components of the hinge, including the door attachment components of the hinge as well as the hinge itself, may be attached to the external surface of the door rather than the interior portion of the door or between the door and the fender body of the vehicle. In those traditional vehicles, the hinge is not exposed to the weather and other elements of the outside environment, whereas hinges attached to the external surface of the doors of vehicles are exposed to the outside environment. Detrimentally, such exposure to the outside environment enables the effects of the weather, such as rain, snow and salt, to facilitate the rusting or corrosion of the material forming the hinges which, combined with the use of the hinges, may contribute to the premature failure of the same, thereby preventing the door from being able to adequately open and close.

The same is true for the hoods of these vehicles where external hinges are used. For purposes of this invention, it will be understood that reference to the doors of vehicles, or door hinges, will also refer to the hoods of the vehicles or hood hinges, respectively, and, where claimed, any reference to a door or door hinge will also include a hood or hood hinge for a vehicle.

Moreover, the external nature of external hinges leaves bolt heads, clips or any other retainers or fasteners used to attach the hinges to the vehicle's doors exposed for anybody to view and access. Still further, it is believed that some owners of these vehicles believe that the utilitarian aspects of the exposed fasteners and retainers of the hinges generally detracts from the vehicle's appearance, while presenting unscrupulous individuals an opportunity to vandalize, remove or otherwise tamper with the fasteners of the hinge, enabling them to gain unauthorized access to the contents of the vehicle. Even further, the external hinges are highly susceptible to physical damage when the vehicle encounters various obstacles, particularly during off-road use of the vehicle.

In addition to allowing the door of the vehicle to be opened and closed, such external hinges may be configured to allow the door to be easily removed from the body of the vehicle. For example, when the vehicle's door is opened, the door may be lifted upward causing the hinge to separate from the frame or body of the vehicle, allowing the door to be removed. Such a feature provides a number of benefits to the user, and is often an important selling point when buyers elect to purchase such a vehicle. Thus, any hinge covers or replacement hinges contemplated for such external hinges of a vehicle would likely need to retain the removable aspects of the door to ensure its commercial acceptance in the marketplace.

Replacement hinges that serve to replace the original equipment hinges of a vehicle exist in the art, and are generally formed from materials, such as billet aluminum, steel, magnesium, and the like which provide a generally pleasing aesthetic, and customized appearance to the outside of the vehicle. However, such replacement hinges are still exposed to the elements of the outside environment, and do not provide any protective benefits to the hinge itself. Rather, such replacement hinges serve only to cosmetically enhance the appearance of the vehicle. That is, replacement hinges still suffer the drawbacks of the externally attached original equipment hinges, which are left exposed to the outside environment as previously discussed.

Therefore, there is a need in the art for a hinge cover for the exposed external hinges of a vehicle that will cover at least the hinge attachment body portion and fasteners that are attached to the exterior door surface of the vehicle. Such a hinge cover may help to prevent vandalism and/or tampering with the door and/or may help to prevent or reduce the exposure of the hinge to environmental elements, such as the weather, as well as physical damage, while still providing an improved aesthetic appearance and possibly allowing for the removal of the door by the owner without the need for removing the hinge cover itself from the door.

### SUMMARY OF INVENTION

Any one or more of the foregoing aspects of the present invention, together with the advantages thereof over the known art relating to hinge covers and, particularly, hinge covers for vehicle doors, which shall become apparent from the specification and drawings that follows, may be accomplished by the invention as hereinafter described and claimed.

In general, the present invention provides a hinge cover assembly for covering an external door hinge disposed on the exterior surface of a vehicle, the hinge cover assembly comprising a hinge cover; and a mounting bracket, wherein said mounting bracket is attached to the external door hinge and wherein said hinge cover is attached to said mounting bracket.

One or more other aspects of the present invention may be achieved by a hinge cover assembly for a vehicle comprising an external hinge disposed on the exterior of the vehicle to open and close a door attached thereto; and a hinge cover adapted to be attached to said external hinge, said hinge cover covering at least part of said external hinge.

Still one or more other aspects of the present invention may be achieved by a method for covering an external hinge of a vehicle comprising: configuring a hinge cover to cover at least a part of the external hinge; and attaching said hinge cover to the external hinge.

Advantageously, it will be appreciated that, in at least one of the embodiments of the present invention, a hinge cover assembly of the present invention allows for the door of the vehicle to be selectively removed from the vehicle, even though the hinge cover disposed on the exposed external door hinge remains attached to the door or door hinge.

### BRIEF DESCRIPTION OF THE DRAWINGS

One or more objects and advantages of the present invention will become apparent from the subsequent detailed description of the preferred embodiment and the appended claims taken in conjunction with the accompanying drawings where:

FIG. 1 is an side elevational view of a portion of a vehicle, such as a utility-type vehicle, showing a pair of exposed external hinges used to pivotably attach the door to the vehicle, whereby one of the external hinges is depicted in an exposed state, while the other external hinge is depicted covered by a hinge cover assembly in accordance with the concepts of the present invention;

FIG. 2 is a closer, perspective view of the exposed external hinge maintained on the exterior surface of the vehicle as shown in FIG. 1;

FIG. 3 is an exploded, perspective view of an external hinge and the hinge cover assembly according to the concepts of the present invention, wherein the hinge cover is in alignment with the external hinge;

FIG. 4 is a perspective view of the underside of a hinge cover in accordance with the concepts of the present invention;

FIG. 5 is an exploded, perspective view of the external hinge and the mounting member of the hinge cover assembly as shown in FIG. 2; and

FIG. 6 is a perspective view of the hinge cover assembly mounted to the external hinge in accordance with the concepts of the present invention.

### DETAILED DESCRIPTION OF THE INVENTION

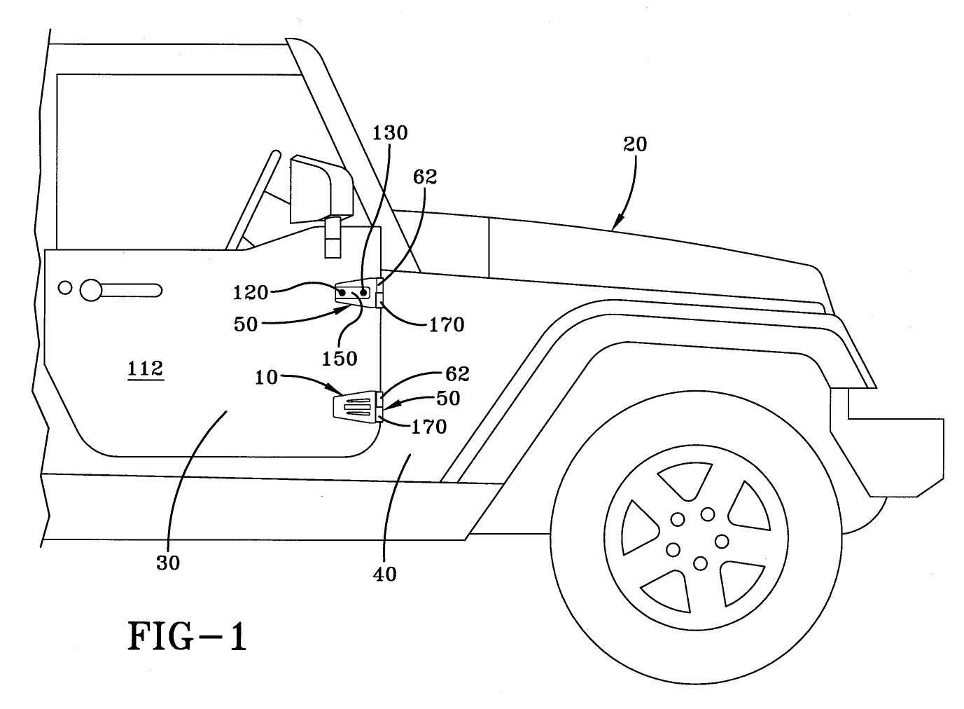

One embodiment of a hinge cover for covering an external hinge, or at least the exposed external attachment body components of the external hinge, of a vehicle, such as a utility-type vehicle, is generally referred to by the numeral 10 in FIG. 1 of the drawings. Before setting forth the specific structural and functional aspects of the hinge cover and, more broadly, the hinge cover assembly, which serves as the primary focus of the following description, a brief description of the external hinge and the environment associated with the external hinge, including the door and the structures that carry the door, are presented to facilitate understanding of the present invention or the hinge cover assembly's environment with respect to a vehicle.

As shown in FIG. 1, the hinge cover 10 is designed for use with a vehicle, generally designated by the numeral 20, which maintains a door 30 that is pivotally attached to a body or frame member 40 of the vehicle 20. The door 30 may be pivotally attached to the frame member 40 by one or more external hinges, designated generally by the numeral 50, which hinges allow the door 30 to be moved around an axis defined by the positioning of the hinges. Where more than one hinge 50 is used, it will be appreciated that the hinges are aligned with each other, and with respect to the door 30 and frame body 50, such that the door 30 is allowed to move around a single axis created by the aligned hinges between opened and closed positions.

It will be further appreciated that the present invention is limited to those vehicles having external hinges defined as any hinge having at least one point of attachment that is disposed on the exterior surface of a vehicle. In one embodiment, the hinge cover 10 is adapted for use with an external hinge 50 that is attached to the exterior surface 112 of a door 30 of the vehicle 20, thereby leaving the external hinge 50, if not covered, exposed to the environment. The external hinge 50 may comprise any assembly, structure or configuration known in the art, provided that it allows the door 30 to pivot between opened and closed positions and that it has at least one point of attachment that is disposed on an exterior surface of the vehicle 20.

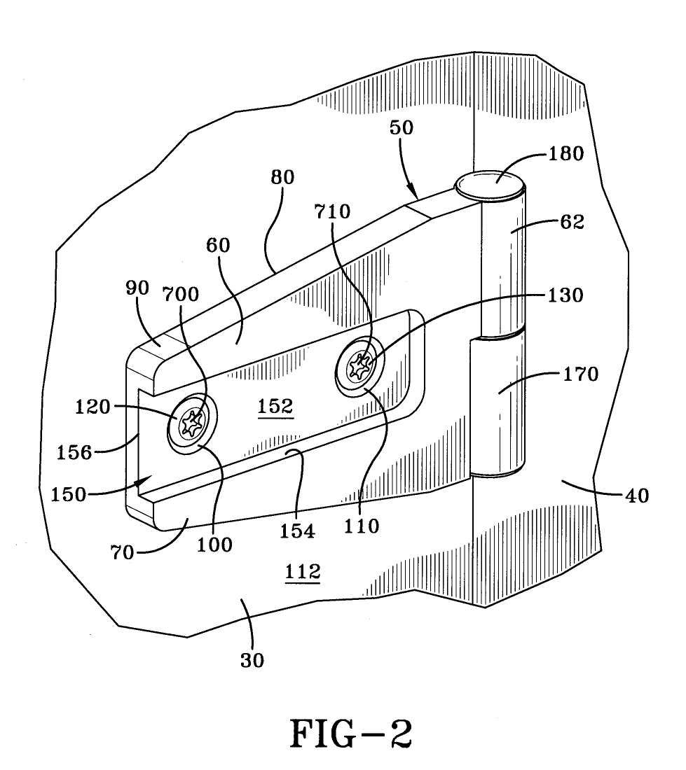

With reference to FIG. 2, one embodiment of an external hinge 50 known in the art is illustrated. The external hinge 50 comprises a hinge body 60 that extends from a pivoting hinge member 62. The hinge body 60 has an outer body surface 70, an inner body surface 80, and a perimeter surface 90 that generally defines the shape and configuration of the hinge body 60. While the hinge body 60 is shown as being substantially trapezoidal in shape in the embodiment disclosed in the drawings, it is to be understood that the hinge body 60 may take on any dimension, configuration or shape suitable for maintaining the hinge on the door 30 and enabling the door 30 to open and close. For example, the hinge body 60 may comprise a shape that is rectilinear, curvilinear or a combination of both.

In addition, while the outer body surface 70 of the hinge 50 is shown as being substantially planar, it is contemplated that the surface 70 may be configured to have any suitable surface contour or shape. Moreover, the hinge body 60 may be configured to have any cross-sectional shape suitable for pivotably attaching the door 30 to the body 40 of the vehicle 20.

In one embodiment, the hinge body 60 may include one or more bores, such as counterbores 100,110, that are dimensioned and aligned with a corresponding number of bores (not shown) disposed in the exterior surface 112 of the door 30, for receiving a respective fastener, such as threaded fasteners 120, 130, therethrough, for securing the external hinge 50 to the door 30. The counterbores 100,110, may be formed to be any suitable shape and, in one embodiment, may be tapered. It will also be appreciated that, in lieu of threaded fasteners 120, 130, any type of fastener (e.g., nails, rivets, pins, etc.) known in the art suitable for use in passing through the counterbores 100, 110 and bores in the exterior surface of the door 30 and adapted for securing the external hinge 50 to the door 30 may be used.

In other embodiments, it will be appreciated that any means of attaching the external hinge 50 to the door 30 may be used. The present invention is not necessarily to be limited to those external hinges having counterbores for receiving fasteners therethrough. Adhesives and other fastening means known in the art may be used in alternative embodiments of the present invention.

In the embodiment depicted in FIG. 2, the counterbores 100,110 may be disposed in a channel, generally identified by the numeral 150, defined in the outer surface 70 of the hinge body 60. The channel 150 includes a channel surface 152 that is countersunk below the outer surface 70 of the hinge 50, and that is bounded and more particularly defined by a channel wall 154 and a channel edge 156. In one embodiment, the channel edge 156 may be disposed distal to the hinge member 62.

The channel 150 may be of any shape or configuration known in the art and suitable for the purposes described. In one embodiment, the channel 150 is substantially rectangular in shape. In other embodiments, no channel may be formed in the outer surface 70 of external hinge body 60.

The pivoting hinge member 62 comprises a cylindrical bore defined thereby, and is configured to be aligned with another cylindrical bore defined by a mounting member 170 attached to the body 40 of the vehicle 20. The aligned cylindrical bores of the pivoting hinge member 62 and the mounting member 170 allow the door 30 to be pivotally attached to the vehicle 20 by a pin 180 that is slidably received and retained within the bores of the hinge member 62 and mounting member 170. Thus, the use of the pin 180 enables the hinge member 62 and the mounting member 170 to be removably joined, so that the door 30 can be selectively removed from the vehicle 20. In other words, the pin 180 is configured so that it may be readily removed from the bore maintained by the mounting member 170, thereby enabling the door 30 to be removed from the vehicle 20. For example, by lifting upward on the door 30 when it is ajar would allow the door 30 to be removed from the vehicle 20. Thus, it is apparent that, because the hinge 50 is arranged to be adjacent the external surface 112 of the door 30, which is exposed to the outside environment, the hinge 50 is susceptible to physical damage, as well as to vandalism, tampering, and to the degredating effects of the weather. It should also be appreciated that the hinge 50 may be formed of any material suitable for supporting and pivotably attaching the door 30 to the vehicle 20, including but not limited to aluminum, steel, or composite material, for example. In light of the particular structural features of the externally attached hinge 50 maintained by the vehicle 20 discussed above, a detailed description of the hinge cover 10 of the present invention can now be appreciated.

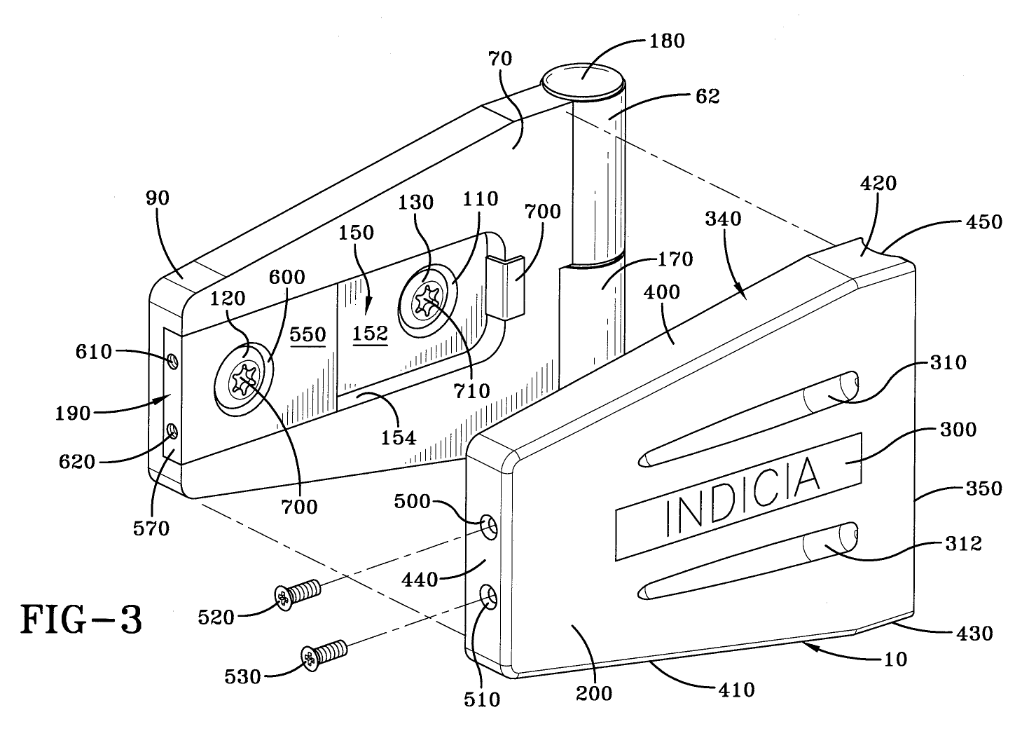

The hinge cover 10, as shown in the drawings and, more particularly, in FIGS. 3-6, is configured to be retrofit or otherwise attached to the external hinge 50 of the vehicle 20 using a hinge bracket 190 or other suitable means of attachment to be discussed. The hinge cover 10 is beneficial as it enables the covering of at least the body attachment components of the hinge body 60, without interfering with the pivoting action of the hinge 50 or with the ability of the door 30 to be removed from the vehicle 20 when the hinge cover 10 is attached. For example, the hinge cover 10 may be configured to occlude, or otherwise cover at least part of the fasteners 120,130 used to attach the hinge 50 to the door 30, so as to inhibit access to the various components of the hinge 50.

As shown in detail in FIGS. 3 and 4, the hinge cover 10 is comprised of opposed outer and inner cover surfaces 200 and 210. The outer cover surface 200 may be designed with any desired ornamental indicia. For example, in one embodiment, the outer cover surface 200 may include indicia, such as at 300, printed or adhered to the cover surface 200. In other embodiments, the outer cover surface 200 may include indicia, such as streaks 310 and 312, engraved or etched into the cover surface 200.

In addition, the outer and inner cover surfaces 200,210 may be formed to take on any desired cross-sectional shape suitable for allowing the cover 10 to be attached to the hinge body 60. In at least one embodiment, the hinge cover 10 may be shaped and dimensioned so that it substantially matches the dimension and shape of the hinge body 60 of the hinge 50. For example, in one embodiment, the hinge cover 10 is dimensioned to be substantially trapezoidal in shape so as to match the substantially trapezoidal shape of the hinge body 60 embodiment maintained by the hinge 50 as previously discussed. However, it should be appreciated that the cover 10 may be dimensioned to take on a shape that is rectilinear, curvilinear, or a combination of both, which covers all or part of the shape and dimension of the hinge body 60.

In at least one embodiment, a wall 340 extending at a substantially right angle from the inner cover surface 210 circumscribes the entire perimeter of the hinge cover 10, except for an attachment edge 350 that is located in a region of the cover 10 that is placed adjacent the hinge and mounting members 62,170 when the hinge cover 10 is attached to the hinge 50. However, it should also be appreciated that the wall 340 may extend at any suitable angle from the inner cover surface 210, so long as the angle enables the cover 10 to receive the edge 90 of the hinge body 60. It will be understood that other embodiments are contemplated whereby the angle of the wall 340 may take on other angles that prevent the cover 10 from receiving the edge 90, while still covering or partially covering the hinge body 60. The wall 340 is dimensioned to have a thickness and cross-sectional profile or shape that accommodates or that is otherwise suitable for receiving or at least partially enclosing the hinge body 60. As such, the wall 340 and the inner cover surface 210 of the hinge cover 10 serves to form a cavity 360 of a suitable dimension to receive or at least partially receive or cover the hinge body 60. Thus, the shape and dimension of the inner cover surface 210 and the wall 240 are dimensioned so that the cavity 360 has a shape or profile that is complementary to the dimension and shape of the hinge body 60. In addition, the hinge cover 10 may be formed from any suitable material, such as aluminum, steel, or plastic. The hinge cover 10 should also be capable of protecting the hinge from exposure to the weather, tampering, and any other physical damage.

The hinge cover 10 may be formed from any combination of translucent, transparent, or opaque material, that may be colored, texturized, coated, or otherwise treated with any desired ornamental embellishment, indicia, design, or the like. In one embodiment, the hinge cover 10 may be at least partially formed from transparent or translucent material, collectively referred to hereinafter as light transmitting material, which is operative to receive light from a light source (not shown), such that light therefrom illuminates the hinge cover 10. The light source may comprise an LED (light emitting diode), HID (high intensity discharge) lights, or any other suitable light source, including, but not limited to electroluminescent, incandescent, or gas-discharge light sources. Moreover, the light source may comprise any desired color of light, and/or may be configured to pulse the light in accordance with any desired cadence or sequence. In another embodiment, the cover 10 may be substantially opaque, with the exception of the indicia 300 which may be formed of light transmitting material, such that it is illuminated by the light source. Alternatively, the indicia 300 and the remaining portions of the cover 10 may both be formed of light transmitting material, whereby the indicia 300 is one color and/or pulsed in one sequence and the remaining portions of the cover are another color and/or pulsed in another sequence. In yet another embodiment, the light source may be mounted remotely from the hinge cover 10, and routed via a light pipe, fiber optic cable, or any other suitable means of directing the light to the hinge cover 10 for illumination thereof.

In one or more embodiments, the hinge cover 10 may be configured such that the wall 340 is perforated, such that any moisture that develops between the hinge 50 and the inner cover surface 210 defining the cavity 360 may be dissipated. Such a feature is beneficial in that moisture that is not able to dissipate in and about the components of the hinge 50 facilitate the wear and corrosion of the hinge 50.

In one embodiment, as shown in the FIG. 3, the wall 340 may include wall members 400 and 410 that extend at an angle from planar wall members 420 and 430, respectively, which wall members 420 and 430 are proximate to the attachment edge 350 of the hinge cover 10. Joining the wall members 400 and 410 is a mounting wall member 440, which is oriented substantially opposite the attachment edge 350. In one embodiment, the wall members 420,430 may have contoured edges 450 and 460, respectively, to accommodate the dimension and profile of the hinge member 62 and the mounting member 170 of the hinge 50. This allows the attachment edge 350 of the hinge cover 10 to be mounted in close proximity to the hinge member 62 and the mounting member 170, such that a high tolerance fitment between the cover 10 and the hinge 50 may be achieved. In at least one embodiment, disposed through the mounting wall member 440 of the wall 340 are two spaced bores 500,510. Bores 500 and 510 are provided to receive fasteners, such as threaded fasteners 520,530, used for attaching the hinge cover 10 to the mounting bracket 190, in a manner to be discussed.

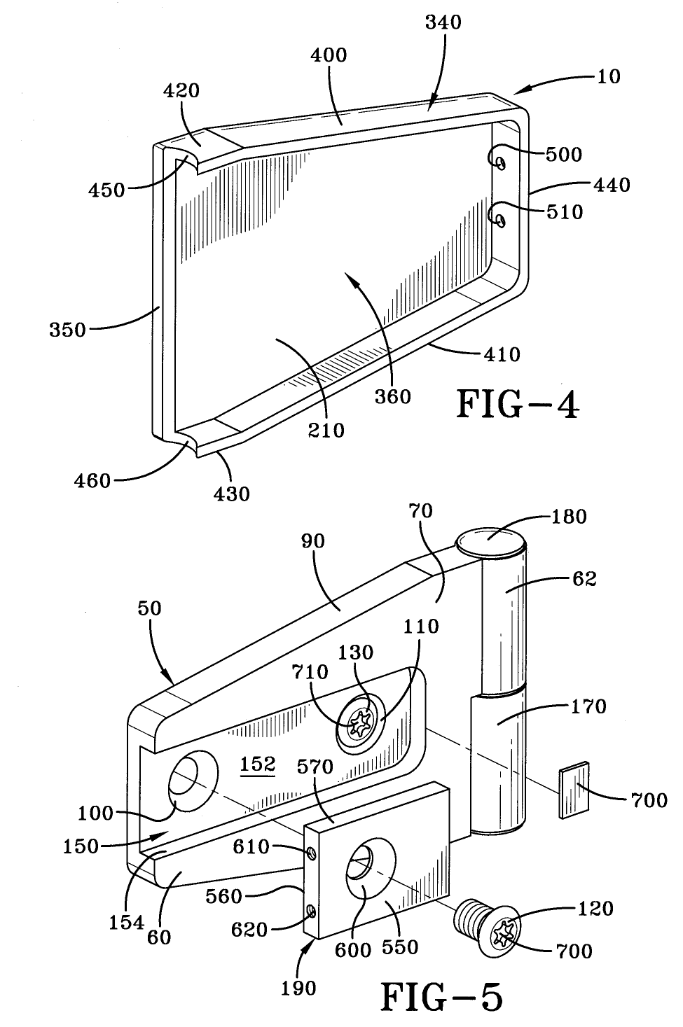

The hinge cover 10, as shown in FIG. 4, is mounted to the hinge body 60 using the mounting bracket 190. In the embodiment illustrated in FIGS. 4 and 5, the mounting bracket 190 comprises an outer bracket surface 550 and an opposing inner bracket surface 560 that are separated by an edge surface 570. The mounting bracket 190 may be formed from any suitable material, including but not limited to aluminum, steel, and plastic, and is dimensioned so that it may be received within the channel 150. For example, the mounting bracket 190 may be rectangular or otherwise dimensioned in shape so that it may be received within the channel 150. In one embodiment, the mounting bracket 190 is formed in a shape that is complementary to that of the channel 150. In another embodiment, the mounting bracket 190 is dimensioned in shape so as to fit suitable between the cover and the hinge 50. Where the mounting bracket is complementary to the channel 150, it will be appreciated that such a dimension prevents the mounting bracket 190 from sliding, rotating, or otherwise being disturbed from its mounted position, thereby increasing the rigidity of the mounting bracket 190. In at least one embodiment, the mounting bracket 190 is dimensioned so that the thickness of the edge 570 is substantially equal to the depth of the channel wall 154 maintained by the hinge body 60. Such arrangement allows the outer bracket surface 550 to be substantially flush, or even with the outer body surface 70 of the hinge 50 when the mounting bracket 190 is placed within the channel 150. In other embodiments, it will be appreciated that the mounting bracket 190 may be positioned in the channel 150 such that the outer bracket surface 550 is just above or below the outer body surface 70 of the hinge 50. Essentially, as long as the cover 10 can be attached to the hinge in the manner to be discussed, the mounting bracket 190 will be sufficient.

A bore, such as counterbore 600, may be disposed through the mounting bracket 190 and may be dimensioned so as to receive a fastener, such as screw 120, used to attach the hinge body 60 to the door 30 of the vehicle 20. In one embodiment, the counterbore 600 may be dimensioned to permit the head, or other exposed portion of the screw 120, to be countersunk below the outer surface 550 of the mounting bracket 190. When installed properly within the channel 150 of the hinge 50, the counterbore 600 is aligned with the counterbore 100 of the hinge 50 such that as the fastening screw is received by the counterbore 600 of the mounting bracket 190, it is further received by the counterbore 100 of the hinge 50, thereby holding the mounting bracket 190 into place on the hinge 50.

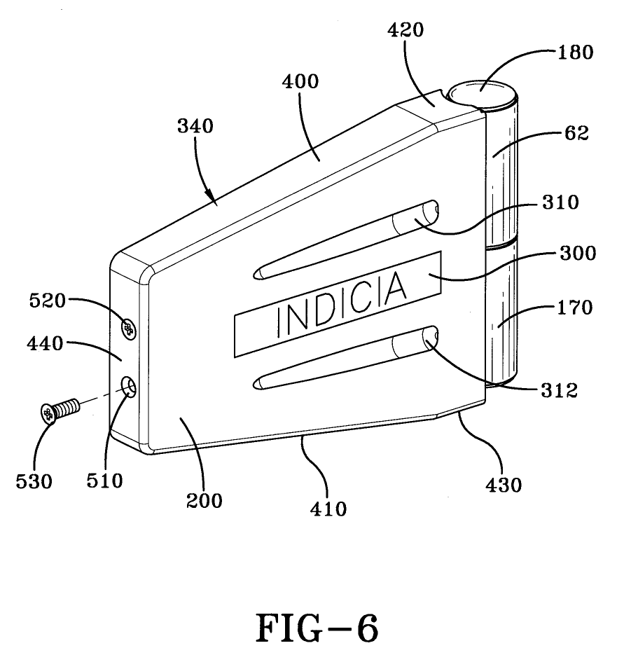

With the mounting bracket 190 installed into place, it should now be appreciated that the hinge cover 10 can be installed. In one embodiment, the mounting bracket 190 may include a plurality of spaced apart, threaded bores 610, 620 disposed within the edge surface 570 most distal to the hinge member 62 and hinge mounting member 1.70. The threaded bores 610,620 may be arranged to substantially align with the bores 500,510 in the hinge cover 10 when the cover 10 is installed. Once aligned, respective threaded fasteners 520,530 may be received therethrough so as to attach the hinge cover 10 to the mounting bracket 190, as shown in FIG. 6. In one embodiment, it will be appreciated that the fasteners 520,530 may comprise torx fasteners, or other fasteners that require a specialized tool for removal, so as to prevent the unauthorized removal of the cover 10. Furthermore, if the hinge 50 is designed without the channel 150, the mounting bracket 190 may still be attached to the hinge body 60 upon the outer surface 70 of the hinge 50 in the manner previously discussed. Alternatively, in lieu of fasteners 520,530, the cover 10 may be attached to the mounting bracket 190 using any suitable fastening means including, but not limited to, rivets, hook and loop, double-sided tape, adhesive, and the like.

It will also be appreciated that, in one embodiment, the hinge cover 10 may be directly attached to the hinge body 60 without the use of the mounting bracket 190. For example, the hinge cover 10 may be attached to the hinge body 60 using any suitable attachment means including, but not limited to, adhesive, rivets, hook and loop, double-sided tape, adhesive, and the like. In another embodiment, the attachment bracket 190 may be configured so that it is not received or is only partially received in the channel 150. Furthermore, if the hinge 50 is designed without the channel 150, the mounting bracket 190 may be disposed directly upon the outer surface 70 of the hinge 50.

With the structural aspects of the hinge cover 10 and the external hinge 50 of the vehicle 20 set forth, the manner in which the hinge cover 10 is installed can be appreciated. Initially, with reference to FIG. 5, the mounting bracket 190 is attached to the hinge body 60 of the hinge 50 by inserting the threaded fastener 120, such as a screw, through the counterbore 600 of the mounting bracket 190 and the counterbore 100 of the hinge body 60 where it is secured. In one embodiment, the mounting bracket 190 may be attached to the hinge body 60, such that the mounting bracket 190 is seated within the channel 150, as shown in FIG. 3. With reference to FIG. 3, once the mounting bracket 190 is attached to the hinge body 60, the hinge cover 10 is oriented so that its dimension and shape are aligned with that of the hinge body 60, such that the attachment edge 350 is placed adjacent the hinge member 62 and the mounting member 170, resulting in the cavity 360 at least partially receiving the dimension or profile of the hinge 50. In other words, the wall member 340 of the hinge cover 10 is disposed about the edge surface 90 of the hinge body 60, such that the hinge cover 10 is placed over the hinge body 60, whereby the cavity 360 defined by the inner cover surface 210 and the wall surface 340 of the hinge cover 10 is adjacent the outer body surface 70. After the hinge cover 10 is aligned and placed over the hinge body 60, the threaded bores 610 and 620 of the mounting bracket 190 are aligned with the bores 500 and 510 of the hinge cover 10. Next, with the bores 500,510 of the hinge cover 10 aligned with the threaded bores 610,620 of the mounting bracket 190, threaded fasteners 520 and 530 are threadably received therethrough, so as to secure the hinge cover 10 to the mounting bracket 190, as shown in FIG. 6. It is also contemplated that a section of double-sided tape 700, or other suitable fastening material, such as silicone or other adhesive, may be disposed upon the outer surface 70 of the hinge body 60, so as to retain the cover 10 thereto to prevent the cover 10 from vibrating against the hinge body 60 when the vehicle 20 is operated. Alternatively, the hinge cover 10 may be oriented so that it is at least partially disposed over the outer surface 70 of the hinge 50, without the outer surface 70 of the hinge 50 being received by the cavity 360.

Alternatively, the hinge cover 10 may be mounted to the hinge 50 without the use of the mounting bracket 190. As such, the hinge cover 10 may comprise one or more rubber grommets (not shown) that extend outwardly from the inner cover surface 210 of the hinge cover 10. The grommets are dimensioned so that they are capable of being frictionally received by drive apertures 700,710 disposed in the head of the fasteners 120 and 130. Thus, the compressive force imparted to the grommets by the drive aperture serves 700,710 to retain the hinge cover 10 in place against the hinge body 60.

It will, therefore, be appreciated that one advantage of one or more embodiments of the present invention is that a hinge cover is provided to cover an exposed external hinge of a vehicle's door, so as to prevent tampering, and to protect the hinge from physical damage, including the degradation effects of the weather. Another advantage of the present invention may be that when the hinge cover is attached to the hinge body maintained by the external hinge, the door of the vehicle may still be removed and reinstalled. Thus, based upon the foregoing, it will be appreciated that the concepts described above provide an improvement in the art.

Thus, it can be seen that one or more aspects of the invention have been satisfied by the structure and methods provided above. In accordance with the Patent Statutes, only the best mode and certain alternative embodiments have been presented in the application and described in any detail. It should be understood that the spirit and scope of the appended claims should not be limited to the description of the embodiments contained herein, the true scope and breadth of the invention being defined by the claims as follows.

What is claimed is:

1. A hinge cover assembly for covering an external door hinge disposed on the exterior surface of a vehicle, the hinge cover assembly comprising:
a hinge cover; and
a mounting bracket, wherein said mounting bracket is attached to the external door hinge and wherein said hinge cover is attached to said mounting bracket.

2. The hinge cover assembly of claim 1, wherein the hinge cover is attached to the mounting bracket by one or more fasteners.

3. A hinge cover assembly for a vehicle comprising:
an external hinge disposed on the exterior of the vehicle to open and close a door attached thereto; and
a hinge cover adapted to be attached to said external hinge, said hinge cover covering at least part of said external hinge.

4. The hinge cover assembly of claim 3, wherein said external hinge comprises:
a hinge member having a pin receiving bore;
a hinge body extending from said hinge member and attached to the door;
a mounting member attached to a frame of the vehicle and having a pin receiving bore aligned with the pin receiving bore of said hinge member; and
a pin received through said pin receiving bores of said hinge member and said mounting member, wherein said hinge cover covers at least part of said hinge body.

5. The hinge cover assembly of claim 4, wherein said pin is removable from said pin receiving bores of said hinge member and said mounting member, to enable removal of the door from the vehicle without removing said hinge cover.

6. The hinge cover assembly of claim 4, further comprising:
a mounting bracket attached to said hinge body by at least one fastener, and configured to enable said hinge cover to be attached to said mounting bracket by at least one fastener, such that said hinge cover covers at least part of said hinge body.

7. The hinge cover assembly of claim 6, wherein said hinge body comprises a channel, said channel receiving at least a portion of said mounting bracket.

8. The hinge cover assembly of claim 6, wherein said mounting bracket and said hinge cover both include at least one bore, each bore of said hinge cover being aligned with a respective bore of said mounting bracket so as to receive a fastener through each aligned bores.

9. The hinge cover assembly of claim 6, wherein said mounting bracket has a counterbore dimensioned to at least partially receive said fastener used to attach said mounting bracket to said hinge body.

10. The hinge cover assembly of claim 4, wherein said hinge cover has an inner surface configured to define a cavity for receiving at least part of said body.

11. The hinge cover assembly of claim 4, wherein said hinge cover includes a contoured edge configured to be proximate said hinge member and said mounting member.

12. A method for covering an external hinge of a vehicle comprising:
configuring a hinge cover to cover at least a part of the external hinge; and
attaching said hinge cover to the external hinge.

13. The method of claim 12, wherein said step of attaching includes securing a mounting bracket to the external hinge and securing said hinge cover to the mounting bracket.

14. The method of claim 12, wherein the external hinge of the vehicle is a hinge attaching a door to the vehicle, and wherein the step of configuring the hinge cover includes configuring the hinge cover so as to permit removal of the door from the vehicle without removing the hinge cover from the external hinge.
